(19) United States
(12) Patent Application Publication
(10) Pub. No.: US 2023/0175717 A1
(43) Pub. Date: Jun. 8, 2023

(54) AIR FILTRATION FOR LIVESTOCK

(71) Applicant: Donaldson Company, Inc., Bloomington, MN (US)

(72) Inventors: Rakesh K. Yadav, Lakeville, MN (US); Charles V. Wihren, Stillwater, MN (US); Sarah A. Schmitz, Savage, MN (US); Michael R. Carlson, Cottage Grove, MN (US)

(21) Appl. No.: 18/075,619

(22) Filed: Dec. 6, 2022

Related U.S. Application Data
(60) Provisional application No. 63/286,816, filed on Dec. 7, 2021.

(51) Int. Cl. F24F 7/003; F24F 8/108

(52) U.S. Cl. CPC F24F 7/003; F24F 8/108; A01K 1/0047

(57) ABSTRACT

A system for filtration for livestock comprises a barn enclosure including a surrounding wall and a ceiling; the enclosure being sized to house livestock; the barn enclosure having a positive internal pressure differential compared to ambient air. An air inlet is in communication with an interior of the barn enclosure; the air inlet drawing in ambient air. A filter arrangement is downstream of the air inlet, cleaning the drawn in ambient air from the air inlet. A conduit having an air vent arrangement is in air flow communication with the filter arrangement and allowing the filtered air to flow through the vent arrangement into the interior of the barn enclosure. An air exhaust is arranged to exhaust air from the interior of the barn enclosure.

This application claims the benefit of U.S. Provisional Application No. 63/286,816 filed Dec. 7, 2021.

### TECHNICAL FIELD

This disclosure relates to systems of air filter for livestock. In certain applications, it concerns air filtration for barns or other enclosures for livestock and methods of use.

### BACKGROUND

Viruses affecting livestock such as poultry, swine, sheep, bovines, etc. can be problematic, for both economic and public health reasons. Porcine reproductive and respiratory syndrome (PRRS), for example, has been a problem in the swine industry. As explained in an article in the National Hog Farmer, “[t]hough a lot has been learned about PRRS, control of the virus is far from accomplished. Great strides have been made, with the recent technological advancements in the area of gene editing, presenting the potential to create a pig immune to PRRS. Progress has also been made with companies releasing live-virus vaccines that help herds build immunity. But several years ago, one of the biggest challenges was reducing the risk of airborne spread.” Kevin Schulz, “Air filtration for swine herds: A historical perspective,” Sep. 6, 2017.

According to the Schulz publication referenced above, Dr. Scott Dee observed in 2003 a new PRRSV strain—184—causing high mortalities in sows. The virus was observed to replicate inside a pig and exhaling aerosols containing a quantity of virus that was significantly higher than from pigs infected with some of the older PRRSV strains. This information led to Dr. Dee's investigation to France, which was using positive pressure barns and high efficiency particulate air filters, which was appearing to prevent infection.

The industry has recognized that air filtration, including HEPA filtration, in combination with positive pressure barns can prevent the airborne spread of PRRS for swine. However, such systems can be expensive and cumbersome. Improvements are desirable.

### SUMMARY

A system for filtration for livestock is provided. The system comprises a barn enclosure including a surrounding wall and a ceiling; the enclosure being sized to house livestock; the barn enclosure having a positive internal pressure differential compared to ambient air. An air inlet is in communication with an interior of the barn enclosure; the air inlet drawing in ambient air. A filter arrangement is downstream of the air inlet, cleaning the drawn in ambient air from the air inlet. A conduit having an air vent arrangement is in air flow communication with the filter arrangement and allowing the filtered air to flow through the vent arrangement into the interior of the barn enclosure. An air exhaust is arranged to exhaust air from the interior of the barn enclosure.

In example systems, the filter arrangement cleans at least 250,000 cubic feet/minute of air.

The filter arrangement can include a plurality of removable and replaceable filter elements.

In preferred systems, the plurality of elements is determined by an equation:

S=(n_{LV}×f_{LV})/f_{Rated}
wherein:
S=−number of filter elements;
n_{LV}: Total number of livestock to be housed;
f_{LV}: Desired flow per livestock, cfm;
f_{Rated}: Rated flow per filter element, cfm

The filter arrangement can include 250 or fewer filter elements.

In many examples, each of the filter elements has a filtration rating of MERV 14-16.

In some examples, each of the filter elements has a filtration rating of HEPA.

In some embodiments, each of the filter elements has a maximum burst pressure of 25 inches of water column.

In example arrangements, the barn enclosure has a positive internal pressure differential compared to ambient air of up to 1.5 in. water column.

Many examples include each of the filter elements has an initial pressure drop in a range of 1-1.5 inches of water column, when running with a flow of 1000 cfm.

The conduit may be arranged adjacent to the ceiling.

In some examples, the filter arrangement includes: a support grid having a frame with opposite upstream and downstream sides; a plurality of first filter elements oriented along the upstream side of the support grid; and a plurality of second filter elements oriented on the support grid on the downstream side directly across and opposing the first filter element

In some embodiments, the first filter elements comprise pocket filter elements; and the second filter elements comprise V-bank filter elements.

In one or more embodiments, the system further includes an evaporative cooling system downstream of the filter arrangement.

Preferred systems further include an electronic monitoring system to manage one or all of pressure, temperature, and humidity.

The above systems can be used in a method for filtering a livestock enclosure. The method includes providing a barn enclosure including a surrounding wall and a ceiling; the enclosure being sized to house livestock; the barn enclosure having an air inlet in communication with the interior of the barn enclosure drawing in ambient air.

The method includes providing the barn enclosure with a positive internal pressure differential compared to ambient air.

The method includes drawing in ambient air through the air inlet, filtering the drawn in ambient air from the air inlet by passing the drawn in air through a filter arrangement, and venting the filtered air through a conduit to flow into the interior of the barn enclosure.

The method also includes exhausting air from the interior of the barn enclosure through an air exhaust.

The step of filtering through the filter arrangement includes filtering through a plurality of removable and replaceable filter elements.

The step of filtering through a plurality of removable and replaceable filter elements includes a number of filter element determined by an equation:

S=(n_{LV}×f_{LV})/f_{Rated}
wherein:
S=−number of filter elements;
n_{LV}: Total number of livestock to be housed;
f_{LV}: Desired flow per livestock, cfm;
f_{Rated}: Rated flow per filter element, cfm

In example methods, the barn enclosure is provided with a positive internal pressure differential compared to ambient air of up to 1.5 in. water column.

In example method, the step of filtering includes providing each of the filter elements with an initial pressure drop in a range of 1-1.5 inches of water column, when running with a flow of 1000 cfm.

In example methods, the barn enclosure is provided such that the conduit is adjacent to the ceiling.

Aspect 1. A system for filtration for livestock; the system comprising: a barn enclosure including a surrounding wall and a ceiling; the enclosure being sized to house livestock; the barn enclosure having a positive internal pressure differential compared to ambient air; an air inlet in communication with an interior of the barn enclosure; the air inlet drawing in ambient air; a filter arrangement downstream of the air inlet, cleaning the drawn in ambient air from the air inlet; a conduit having an air vent arrangement; the conduit being in air flow communication with the filter arrangement and allowing the filtered air to flow through the vent arrangement into the interior of the barn enclosure; and an air exhaust arranged to exhaust air from the interior of the barn enclosure.

Aspect 2. The system of aspect 1 wherein the filter arrangement includes a plurality of removable and replaceable filter elements.

Aspect 3. The system of aspect 2 wherein the plurality of elements is determined by an equation:

S=(n_{LV}×f_{LV})/f_{Rated}
wherein:
S=−number of filter elements;
n_{LV}: Total number of livestock to be housed;
f_{LV}: Desired flow per livestock, cfm;
f_{Rated}: Rated flow per filter element, cfm.

Aspect 4. The system of aspect 2 wherein the filter arrangement includes 250 or fewer filter elements.

Aspect 5. The system of any one of aspects 2-4 wherein each filter element comprises a cylindrical construction of pleated media.

Aspect 6. The system of any one of aspects 2-5 wherein each of the filter elements has a filtration rating of MERV 14-16.

Aspect 7. The system of any one of aspects 2-6 wherein each of the filter elements has a filtration rating of HEPA.

Aspect 8. The system of any one of aspects 2-7 wherein each of the filter elements has a maximum burst pressure of 25 inches of water column.

Aspect 9. The system of any one of aspects 1-8 wherein the barn enclosure has a positive internal pressure differential compared to ambient air of up to 1.5 in. water column.

Aspect 10. The system of any one of aspects 2-9 wherein each of the filter elements has an initial pressure drop in a range of 1-1.5 inches of water column, when running with a flow of 1000 cfm.

Aspect 11. The system of any one of aspects 1-10 wherein the conduit is adjacent to the ceiling.

Aspect 12. The system of any one of aspects 1-3 wherein the filter arrangement includes: (a) a support grid having a frame with opposite upstream and downstream sides; (b) a plurality of first filter elements oriented along the upstream side of the support grid; and (c) a plurality of second filter elements oriented on the support grid on the downstream side directly across and opposing the first filter element.

Aspect 13. The system of aspect 12 wherein: (a) the first filter elements comprise pocket filter elements; and (b) the second filter elements comprise V-bank filter elements.

Aspect 14. The system of any one of aspects 12 and 13 further including a single clamp system releasably securing both the first filter elements and the second filter elements to the frame.

Aspect 15. The system of any one of aspects 1-14 further including an evaporative cooling system downstream of the filter arrangement.

Aspect 16. The system of any one of aspects 1-15 further including an electronic monitoring system to manage one or all of pressure, temperature, and humidity.

Aspect 17. The system of any one of aspects 1-16 wherein the filter arrangement is located outside of the barn enclosure.

Aspect 18. A method for filtering a livestock enclosure; the method comprising: (a) providing a barn enclosure including a surrounding wall and a ceiling; the enclosure being sized to house livestock; the barn enclosure having an air inlet in communication with the interior of the barn enclosure drawing in ambient air; (b) providing the barn enclosure with a positive internal pressure differential compared to ambient air; (c) drawing in ambient air through the air inlet; (d) filtering the drawn in ambient air from the air inlet by passing the drawn in air through a filter arrangement; (e) venting the filtered air through a conduit to flow into the interior of the barn enclosure; and (f) exhausting air from the interior of the barn enclosure through an air exhaust.

Aspect 19. The method of aspect 18 wherein filtering through the filter arrangement includes filtering through a plurality of removable and replaceable filter elements.

Aspect 20. The method of aspect 19 wherein filtering through a plurality of removable and replaceable filter elements includes a number of filter elements determined by an equation:

S=(n_{LV}×f_{LV})/f_{Rated}
wherein:
S=−number of filter elements;
n_{LV}: Total number of livestock to be housed;
f_{LV}: Desired flow per livestock, cfm;
f_{Rated}: Rated flow per filter element, cfm.

Aspect 21. The method of any one of aspects 18-20 wherein the barn enclosure is provided with a positive internal pressure differential compared to ambient air of up to 1.5 in. water column.

Aspect 22. The method of any one of aspects 19 and 20 wherein the step of filtering includes providing each of the filter elements with an initial pressure drop in a range of 1-1.5 inches of water column, when running with a flow of 1000 cfm.

Aspect 23. The method of any one of aspects 18-22 wherein barn enclosure is provided such that the conduit is adjacent to the ceiling.

A variety of examples of desirable features or methods are set forth in the description that follows.

### BRIEF DESCRIPTION OF THE DRAWINGS

FIG. 1 is a schematic view of a system of filtration for livestock;

FIG. 2 is an example embodiment of an air inlet and filtration arrangement, useable with the system of FIG. 1;

FIG. 3 is another example embodiment of an air inlet and filtration arrangement showing an array of filter elements installed in a tubesheet, useable with the system of FIG. 1;

FIG. 4 is a perspective view of an embodiment of a filtered air aperture arrangement in the tubesheet of FIG. 3, which receives one of the filter elements of FIG. 3;

FIG. 5 is a perspective view of an embodiment of a rod and pivotable handle secured to the filter air aperture arrangement of FIG. 4;

FIG. 6 is a perspective view of an embodiment of one of the filter elements used in the system of FIG. 3;

FIG. 7 is an exploded, perspective view of a clamp system used in FIG. 2;

FIG. 8 is an enlarged front view of a portion of the clamp system during one step of servicing the second filter elements;

FIG. 9 is a perspective view showing one step of servicing the second filter elements;

FIG. 10 is an enlarged view showing a cross-section of both the first filter element and second filter element in sealing engagement against the support grid of the gas turbine air inlet system; and

FIG. 11 is a perspective view of a portion of the system of FIG. 2 with both the first filter element and second element in place against the support grid and the clamp system engaged securing both the first filter element and second filter element.

### DETAILED DESCRIPTION

Filtration systems can be used to filter incoming air to prevent airborne viruses. Such applications can include livestock environments, such as swine farms, poultry, and other livestock in which airborne viruses could transmit.

In the prior art, a negative pressure air filtration with under 0.2 inch of water column of pressure differential for sizing of the system has been used. In these prior art systems, to provide high efficiency filtration and required flow, a significantly large systems are required. The systems described in this disclosure are about ⅓-½ of the size of prior art solutions with significantly reduced maintenance and operational resources.

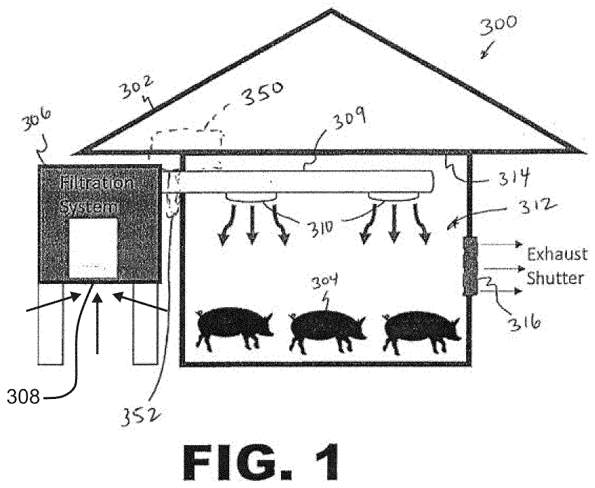

A. Example System, FIG. 1

A system in accordance with principles of this disclosure in shown in FIG. 1 at 300. The system 300 includes a barn enclosure 302 with an interior volume 312 having a positive internal pressure. The use of positive pressure results in a smaller system, and has advantages of ease of maintenance and better security during changeover. In examples, it will have a positive pressure differential of up to 0.5-4 inches of water column, for example, 0.75-3 inches, including 1-2 inches, for example about 1.0 inches of water column in a new and clean condition.

Using positive pressure results in air leaving the interior volume 312 without circulating back in. In this way, any airborne particle that originates in the enclosure 302 will be filtered out. Germs, particles, and other potential contaminants in the surrounding environment will not enter the enclosure 302.

Positive pressure rooms both require a number of components to remain effective: Building positive a pressure room requires the use of specialized construction and climate control equipment. For example, the enclosure 302 can include: a self-closing entryway with an adequate seal; sealed floors, ceiling, walls, and window; fans and ductwork to move air in the desired directions; and/or a monitoring system that allows users to adjust pressure when necessary.

In reference now to FIG. 1, barn enclosure 302 is shown and can be for a variety of livestock such as swine 304, or can be for poultry (e.g., chickens, turkeys), sheep, goats, cattle/bovines, horses, etc.

The system 300 includes a filtration system 306. The filtration system 306 draws in air from the outside atmosphere at an inlet region 308. The air is filtered to remove contaminants, including viruses, and the filtered air flows through a conduit 309 and exits through a vent arrangement 310 in the interior 312 of the barn 302. As shown here, the vent arrangement 310 is adjacent a ceiling 314 of the livestock area in the interior 312 of the barn 302. Interior air from the interior 312 of the barn 302 is exhausted to the outer atmosphere from the barn 302 through an air exhaust arrangement 316.

As can be seen, the filtration system 306 is located outside of the barn 302. When the system 306 is serviced by having the filters changed, this is done outside of the barn 302 which keeps any contaminates outside of the barn 302.

A variety of filter arrangements 306 are usable. Preferably, static positive pressure air filtration systems using small turbine units can be used. Filter elements with filtration ratings from MERV 14-16 or HEPA can be applied to capture relevant airborne viruses.

Preferably, the filter arrangement 306 will clean at least 250,000 CFM of air. The filter arrangement will typically have 300 or fewer elements, for example 80-100 elements, such as about 90 filter elements. Multiple filter arrangements 306 can be configured to meet overall air flow requirements based on livestock population to be housed.

In the prior art, a negative pressure air filtration with under 0.2 inch of water column of pressure differential for sizing of the system is used. In these prior art systems, to provide high efficiency filtration and required flow, significantly large systems are required. The systems described in this disclosure are about ⅓ of the size of prior art solutions with significantly reduced maintenance and operational resources.

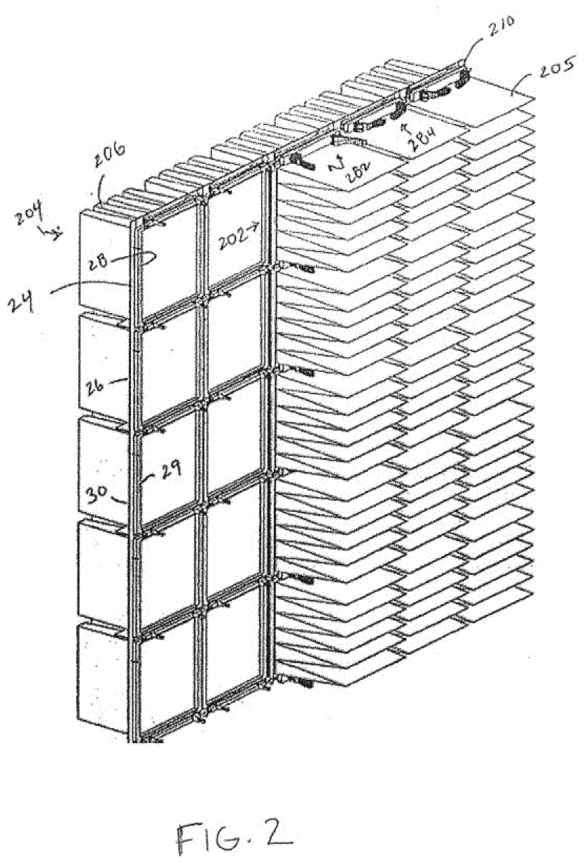

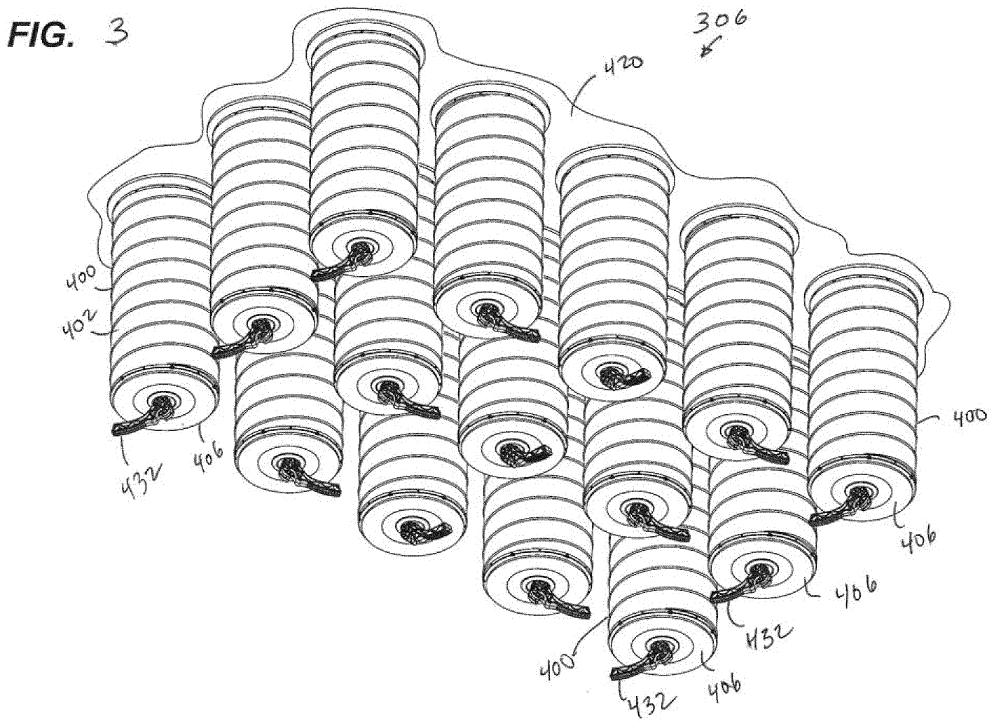

B. Example Filtration System, FIG. 2

In FIG. 2, an example air inlet 308 and filtration system 306 is shown. There are rows and columns of filter elements arranged on a tube sheet or support grid 24. The support grid 24 includes frame 26 having upstream side 29 and opposite downstream side 30. Each opening in the support grid 24 accommodates at least one first filter element 202 on the upstream side 29 and one second filter element 204 on the downstream side 30. The support grid 24 includes a matrix of several first filter elements 202 on the upstream side 29 and second filter elements 204 on the downstream side 30.

As depicted, the first filter element 202 and second filter element 204 are typically oriented on the support grid 24 directly across from each other and covering one of the openings 28 in the support grid 24.

Many different types of filter elements can be used. In the example shown, the first filter elements 202 comprise pocket filter elements 205, while the second filter elements 204 comprise v-bank filter elements 206.

Example pocket filter elements 205 are described in U.S. Pat. No. 7,931,723, incorporated herein by reference. Typical pocket filter elements 205 have pleated media arranged in a V-pack shape, in which each leg or half of the “V” has a plurality of folded or pleated media. Each leg is joined to an adjacent leg at an intersection (vertex) to form the V-pocket or “V-pack.”

Example v-bank filter elements 206 are described in U.S. Pat. Nos. 8,425,644, 10,486,094, 7,334,490, 9,623,356, and 8,951,321, each of which is incorporated herein by reference. Example v-bank filter elements 206 typically include a housing having two or more pairs of filter banks, where the filter banks further include two filter media elements, arranged in a V-configuration. The V-bank filter assembly is generally formed by applying a sealant between the edges of the filter media elements and the housing. In this manner, all of the filter media elements are connected to each other and to the housing.

While the example in FIG. 2 shows filter elements 202 on the upstream side 29 and second filter elements 204 on the downstream side 30, it should be understood that in alternate arrangements, filter elements can be only on either the upstream side 29 or downstream side 30.

In other arrangements, rather than using pocket filter elements 205 or v-bank filter elements 206, the filter elements can be panel filter elements, using pleated media or media comprising opposite first and second flow faces with flutes extending in a direction therebetween; and a sidewall extending between the first and second flow faces; at least some of the flutes having an upstream portion adjacent the first flow face being open and a downstream portion adjacent the second flow face being closed; and at least some of the flutes having an upstream portion adjacent the first flow face being closed and a downstream portion adjacent the second flow face being open.

C. Example Clamp System Useful with the FIG. 2 Filtration System

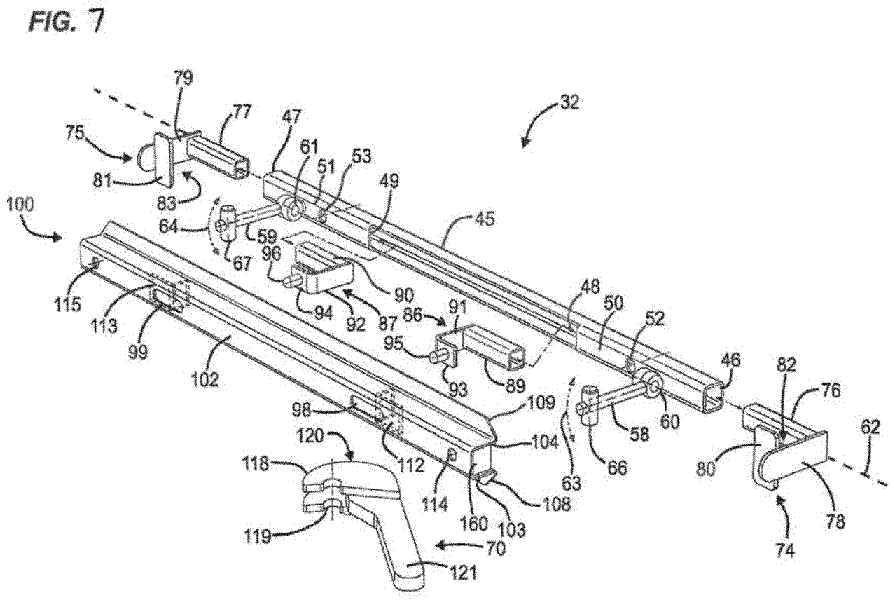

In reference now to FIGS. 7-11, an example clamp system 32 is illustrated in an exploded view.

The clamp system 32 is used for releasably attaching the filter assembly, comprising the first element 202 and the second element 204 to the support grid 24. The clamp system 32 allows for using the single system 32 to hold both the first filter element 202 and the second filter element 204 in place in sealing engagement on the support grid 24. While the second filter element 204 remains in sealing engagement on the support grid 24, the clamp system 32 can be released to allow for removal and replacement of the first filter element 202. The clamp system 32 also allows for periodic removal and replacement of second element 204. Typically, the first filter elements 20 need removal and replacement at more frequent intervals than the second elements 204.

The clamp system 32 includes an elongated support member or tube 45. The support tube 45 has first and second opposite open ends 46, 47. The support tube 45 also includes a first slide channel 48 adjacent to the first end 46, and a second slide channel 49 adjacent the second end 47. The first and second slide channels 48, 49 are formed by openings in the tube 45 spaced from the ends 46, 47. As can be seen, there is a first enclosure 50 and a second enclosure 51, such that the region between the ends of the enclosure 50, 51 and the open ends 46, 47 is an enclosed open through channel.

The tube 45 further includes a through hole 52 through the enclosure 50 and a remaining portion of the tube 45 and a through hole 53 through the enclosure 51 and a remaining portion of the tube 45. The through holes 52, 53 receive projections or pegs 55, 56 (FIG. 1) extending from the frame 26 of the support grid 24. This allows for mounting of the tube 45 on and against the frame 26 of the grid 24.

The clamp system 32 further includes first and second pivot rods 58, 59. The first and second pivot rods 58, 59 each has a swivel type hinge point 60, 61 held within the support tube 45 within a respective one of the enclosures 50, 51. The first and second pivot rods 58, 59 pivot along a pivot axis 62 which is along a length of the support tube 45 between the first and second open ends 46, 47. Arrows 63, 64 show in general the direction of pivoting of the rods 58, 59 about their hinge points 60, 61. The purpose for this pivoting is described further below.

In addition, in FIG. 7, each of the first and second pivot rods 58, 59 includes a barrel nut 66, 67 on a portion of the pivot rod 58, 59 that is remote from or opposite of the hinge points 60, 61. The barrel nuts 66, 67 allow for engagement with a maintenance tool 70, described further below.

The clamp system 32 further includes a first clamp 74 slidably mounted in the first open end 46 and a second clamp 75 slidably mounted in the second open end 47. Each of the first clamp 74 and second clamp 75 includes a slide rod 76, 77 sized to slide within one of the first and second open ends 46, 47 of the support tube 45. An extension or post 78, 79 is secured to and perpendicular to the respective slide rod 76, 77. A flange 80, 81 is secured to a distal portion of the respective post 78, 79 and is parallel to and facing the slide rod 76, 77 to form a gasket holding recess 82, 83 therebetween. The first clamp and second clamp 74, 75 releasably hold the first filter elements 202 in place in sealing engagement.

The clamp system 32 further includes a first slide pin arrangement and a second slide pin arrangement 86, 87. The first slide pin arrangement 86 is slidably mounted in the first slide channel 48 between a locked and a released position. The second slide pin arrangement 87 is slidably mounted in the second slide channel 49 between a locked and released position. In the locked position, the second filter element 204 is secured in place against the grid 24. In the unlocked position, the second filter element 204 can be removed from the grid 24 for servicing (replacement). This is described further below.

Each of the first and second slide pin arrangements 86, 87 includes a pin slide rod 89, 90 sized to slide within a respective one of the first and second slide channels 48, 49. The slide channels 48, 49 are within the enclosures 50, 51. Each of the first and second slide pin arrangements 86, 87 further includes a respective support 91, 92 secured to and perpendicular to the pin slide rod 89, 90.

A pin flange 93, 94 is secured to a distal portion of the respective support 91, 92 and parallel to the pin slide rod 89, 90 with an interior side of the pin flange 93, 94 facing the respective pin slide rod 89, 90. The pin flange 93, 94 also has an opposite exterior side. Each of the first and second slide pin arrangements 86, 87 further includes a pin 95, 96. The pins 95, 96 project from the exterior side of the pin flange 93, 94 and is sized to slide within first and second slots 98, 99 of an omega clamp 100.

The clamp system 32 includes elongated omega clamp 100. The omega clamp 100 is removably mounted to cover the support tube 45. The omega clamp 100 includes a base 102 with a pair of legs 103, 104 extending perpendicular to the base 102. The base 102 defines the first and second through slots 98, 99, which accommodate the pins 95, 96. As can be seen in FIG. 7, the slots 98, 99 are spaced from the opposite ends of the omega clamp 100 and also spaced from each other.

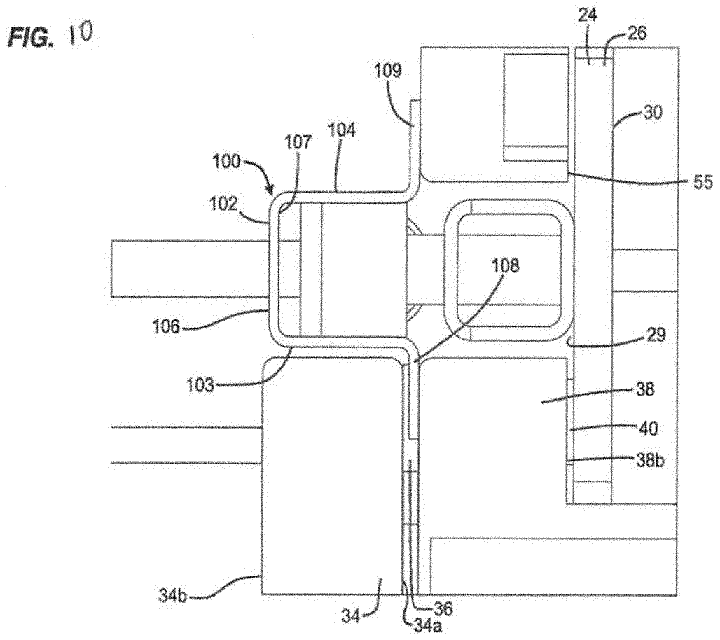

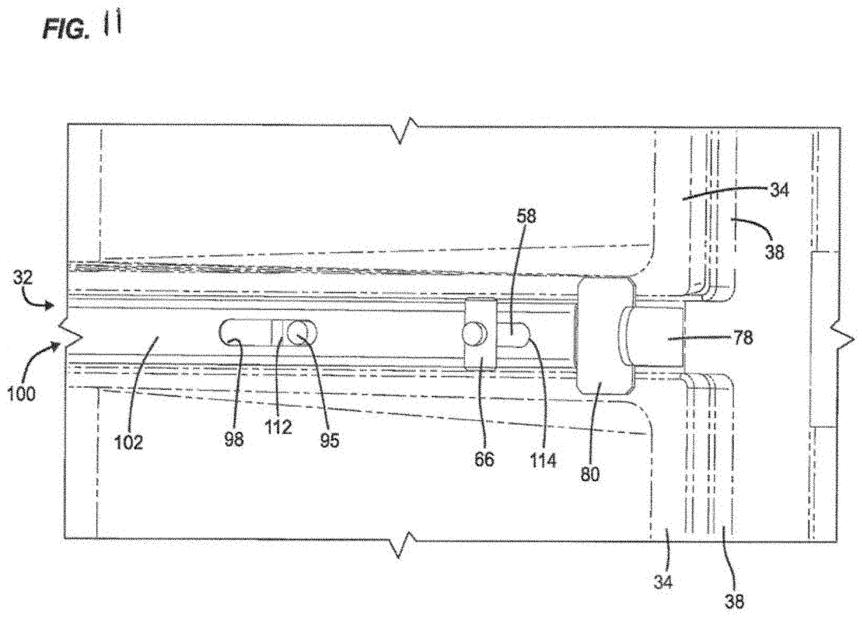

The base 102 had an exterior side 106 (FIG. 10) and an opposite interior side 107 (FIG. 10). Each of the legs 103, 104 is bent at a non-zero angle remote from the base 102 and away from each other to form pressing flanges 108, 109. The non-zero angles can include a range of, for example, 30-90° of the pressing flanges 108, 108 from the portion of the legs 103, 104 that are perpendicular to the base 102, but many embodiments are possible. The legs 103, 104 and the interior side 107 of the base 102 define an open channel 110.

The omega clamp 100 further includes first and second pin slider keepers 112, 113. In FIG. 7, the pin slider keepers 112, 113 are shown in broken lines, as they are on the interior side 107 of the base 102. The slider keepers 112, 113 overlap a portion of the first and second through slots 98, 99.

The first and second pin slider keepers 112, 113 are sized to slidably receive a respective one of the pin flanges 93, 94 to put the first and second slide pin arrangements 86, 87 in the locked positions. When the first and second slide pin arrangements 86, 87 are slid to the released position, the omega clamp 100 is free to be pivoted with the first and second pivot rods 58, 59 along the pivot axis 62 and away from covering the support tube 45. That is, when the first and second pin slide arrangements 86, 87 are slid to the released position, each of the pin flanges 93, 94 is slid to be free of the first and second pin slider keepers 112, 113, and the omega clamp 100 is free to be pivoted along the pivot axis 62 in the direction of arrow 63, 64.

When assembled, the first and second pivot rods 58, 59 extend through and connect the omega clamp 100 and the support tube 45. The base 102 of the omega clamp 100 includes through holes 114, 115, which accommodate the pivot rods 58, 59.

Still in reference to FIG. 7, the clamp system 32 includes a separate maintenance tool 70. The maintenance tool 70 is constructed and arranged to engage each of the first and second pivot rods 58, 59 and apply an axial force against the omega clamp 100 during servicing of the second filter elements 204.

The maintenance tool 70 includes a head 118 defining a recess 119 sized to engage the first and second pivot rods 58, 59. The head 118 includes a cam surface 120 on a portion of the head 118 opposite of the recess 119. The maintenance tool 70 also includes a grasping handle 121 sized to be gripped by a human hand. The grasping handle 121 extends from the head 118.

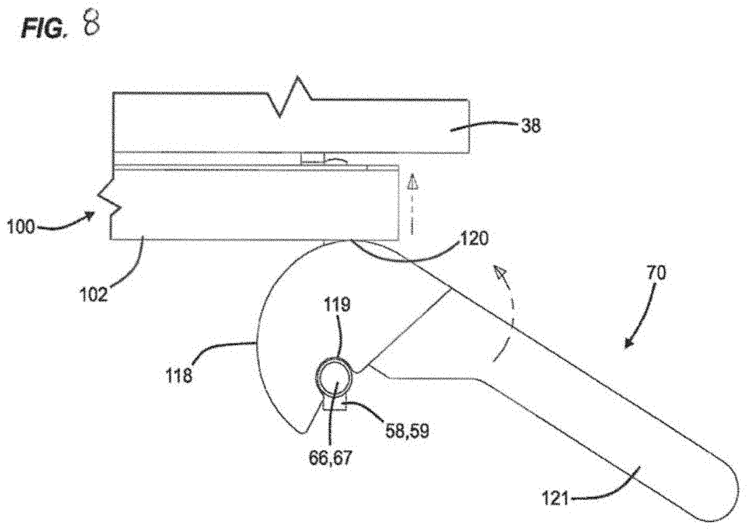

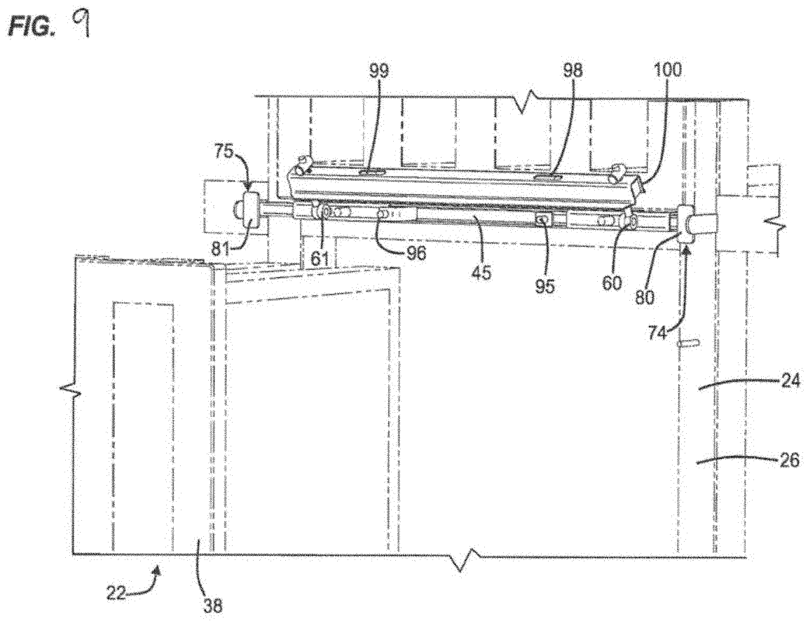

As can be seen in FIG. 8, the maintenance tool 70 can be used so that the recess 119 is placed on the barrel nut 66, 67 of a respective one of the pivot rods 58, 59. The maintenance tool 70 is then rotated or pivoted about the barrel nut 66, 67, and this moves the camming surface 120 against the omega clamp 100. Specifically, the camming surface 120 can be moved to provide a force against the base 102 of the omega clamp 100. This then applies pressure to the frame 38 of the second element 204 to press against the gasket 40 of the second element 204.

FIG. 11 shows a portion of the system when the first element 202 and second element 204 are in place, and the clamp system 32 is engaged securing both elements 202, 204 in place. The pin 95 of the first slide pin arrangement 86 can be seen in a locked position, in which it is in the position to the most outside portion of the first slide 98. It is being held by the first slider keeper 112. The first pivot rod 58 can been seen extending through the hole 114 in the omega clamp 100. The flange 80 of the first clamp 74 can be seen pressing against the frame 34 of the first filter element 202.

In FIG. 2, the maintenance tools 70 are depicted in an unlocked position shown at 282 and a locked position shown at 284.

D. Example Filtration System, FIGS. 3-6

FIGS. 3-6 show another example filtration system 306 is depicted. The system 306 includes an arrangement of filter elements 400. One example filter element 400 is shown in FIG. 6. The element 400 is generally a cylindrical construction of pleated filter media between opposite end caps 404, 406.

The end cap 404 can be many shapes, but in the example shown, it has a seal arrangement 410 along an inner radial surface 412 including an inwardly radially directed seal surface 414 and a thickness that varies along the seal member surface 414. The thickness of the seal member surface varies in a radial direction along the seal member surface 414. Preferably, a length of the seal member 414 surface is constant in an axial direction.

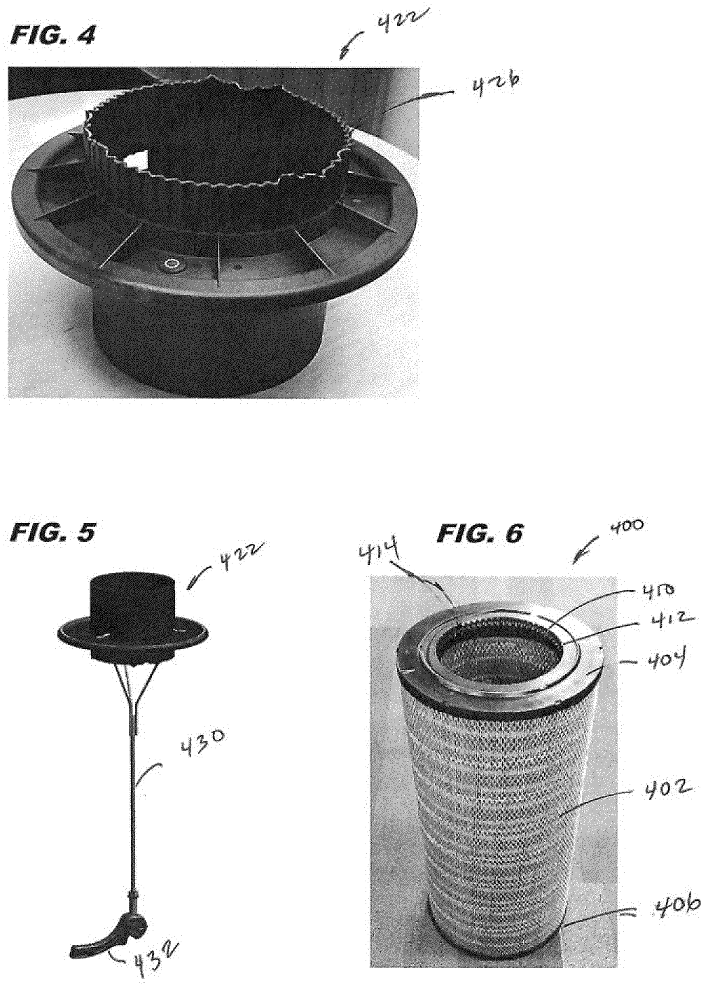

The end cap 404 can form a seal with a portion of a tubesheet 420 (FIG. 3). The tubesheet 420 can have a filtered air aperture arrangement 422 (FIG. 4), with an outwardly radially directed seal surface 426 and a thickness that varies along the seal member surface 426, sized and arranged to receive the seal surface 414.

The filter elements 400 can be removably secured to the tubesheet 420 using a rod 430 with a pivotable handle 432. Example filter elements 400 and securing systems are described in US 2021/0046415, incorporated herein by reference. The filter elements 400 can also be made in accordance with those described in U.S. Pat. No. 10,625,191, incorporated herein by reference.

In another example, the filter elements can be HEPA z-flow media packs. For example, each of the elements may have a filtration media pack with a plurality of layers of single facer media wherein the layers of single facer media include a fluted sheet, a facing sheet, and a plurality of flutes extending between the fluted sheet and the facing sheet. The flutes have a flute length extending from a first face of the filtration media pack to a second face of the filtration media pack. A first portion of the plurality of flutes is closed to unfiltered fluid (such as air) flowing into the first portion of the plurality of flutes, and a second portion of the plurality of flutes is closed to unfiltered fluid flowing out of the second portion of the plurality of flutes so that fluid passing into one of the first face or the second face of the media pack and out the other of the first face or the second face of the media pack passes through media to provide filtration of the fluid. The fluted sheet and facing sheet are formed of multilayer media that can include a polytetrafluoroethylene (PTFE) layer supported by a polymeric scrim layer. The facing sheet is typically not fluted, but in some embodiments the facing sheet is also fluted. The polymeric scrim can be, for example, a spunbond material with high uniformity in the media, such as uniformity of fiber diameter (thickness) or fiber distribution. The filter elements can be made in accordance with those described in WO 2021/195275, published Sep. 30, 2021, incorporated herein by reference.

The number of filter elements 400 used in the system 306 is determined, based on the number of livestock housed; the desired flow per livestock, and the rated flow per filter element. For example, the number of filter elements 400 can by determined by an equation:

S=(n_{LV}×f_{LV})/f_{Rated}
wherein:
S=−number of filter elements;
n_{LV}: Total number of livestock to be housed;
f_{LV}: Desired flow per livestock, cfm;
f_{Rated}: Rated flow per filter element, cfm

In many examples, there will be 250 or fewer filter elements 400.

In many examples, each of the filter elements 400 has a maximum burst pressure of about 20-30 inches of water column, for example, a maximum burst pressure of 25 inches of water column. Each of the filter elements 400 has an initial pressure drop (in a new and clean condition) in a range of 0.75-2 inches of water column, for example about 1-1.75 inches of water column, and in some examples about 1.5 inches of water column when running with a flow of 1000 cfm. By “burst pressure”, it is meant the pressure at which causes the filter element to become overloaded with contaminates to the point that the filter media breaks away or separates from the filter body or frame.

The system 300 can use an electronic monitoring system 350 to manage system parameters, such as one or all of pressure, temperature, and humidity. For example, the monitoring system includes a series of sensor options to track the performance metrics that can be important. Data from each connected device can be collected and sent to a secure cloud, where it is transformed into actionable insights to a dashboard. This web-based dashboard displays the status of all connected inlet air filtration equipment across the operation. One example system is available from the assignee of this disclosure, Donaldson Company, under the name iCue™ Connected Filtration Service. ICue™ is a trademark of Donaldson Company, Bloomington, Minn. Information is available at https://www.donaldson.com/en-us/connected-solutions/, incorporated herein by reference.

In many preferred systems, an evaporative cooling system 352 can be oriented downstream of the filter system 306.

E. Example Methods

The above systems can be used in a method for filtering a livestock enclosure. The method includes providing a barn enclosure including a surrounding wall and a ceiling; the enclosure being sized to house livestock; the barn enclosure having an air inlet in communication with the interior of the barn enclosure drawing in ambient air.

The method includes providing the barn enclosure with a positive internal pressure differential compared to ambient air.

The method includes drawing in ambient air through the air inlet, filtering the drawn in ambient air from the air inlet by passing the drawn in air through a filter arrangement, and venting the filtered air through a conduit to flow into the interior of the barn enclosure.

The method also includes exhausting air from the interior of the barn enclosure through an air exhaust.

The step of filtering through the filter arrangement includes filtering through a plurality of removable and replaceable filter elements.

The step of filtering through a plurality of removable and replaceable filter elements includes a number of filter element determined by an equation:

S=(n_{LV}×f_{LV})/f_{Rated}
wherein:
S=−number of filter elements;
n_{LV}: Total number of livestock to be housed;
f_{LV}: Desired flow per livestock, cfm;
f_{Rated}: Rated flow per filter element, cfm

In example methods, the barn enclosure is provided with a positive internal pressure differential compared to ambient air of up to 1.5 in. water column.

In example methods, the step of filtering includes providing each of the filter elements with an initial pressure drop in a range of 1-1.5 inches of water column, when running with a flow of 1000 cfm.

In example methods, the barn enclosure is provided such that the conduit is adjacent to the ceiling.

Many variations are possible. The above are example principles usable in a variety of arrangements.

What is claimed is:

1. A system for filtration for livestock; the system comprising:
(a) a barn enclosure including a surrounding wall and a ceiling; the enclosure being sized to house livestock;
(b) the barn enclosure having a positive internal pressure differential compared to ambient air;
(c) an air inlet in communication with an interior of the barn enclosure; the air inlet drawing in ambient air;
(d) a filter arrangement downstream of the air inlet, cleaning the drawn in ambient air from the air inlet;
(e) a conduit having an air vent arrangement; the conduit being in air flow communication with the filter arrangement and allowing the filtered air to flow through the vent arrangement into the interior of the barn enclosure; and
an air exhaust arranged to exhaust air from the interior of the barn enclosure.

2. The system of claim 1 wherein the filter arrangement includes a plurality of removable and replaceable filter elements.

3. The system of claim 2 wherein the plurality of elements is determined by an equation:
S=(n_{LV}×f_{LV})/f_{Rated}
wherein:
S=−number of filter elements;
n_{LV}: Total number of livestock to be housed;
f_{LV}: Desired flow per livestock, cfm;
f_{Rated}: Rated flow per filter element, cfm.

4. The system of claim 2 wherein the filter arrangement includes 250 or fewer filter elements.

5. The system of claim 2 wherein each filter element comprises a cylindrical construction of pleated media.

6. The system of claim 2 wherein each of the filter elements has a filtration rating of MERV 14-16.

7. The system of claim 2 wherein each of the filter elements has a filtration rating of HEPA.

8. The system of claim 2 wherein each of the filter elements has a maximum burst pressure of 25 inches of water column.

9. The system of claim 1 wherein the barn enclosure has a positive internal pressure differential compared to ambient air of up to 1.5 in. water column.

10. The system of claim 2 wherein each of the filter elements has an initial pressure drop in a range of 1-1.5 inches of water column, when running with a flow of 1000 cfm.

11. The system of claim 1 wherein the conduit is adjacent to the ceiling.

12. The system of claim 1 wherein the filter arrangement includes:
(a) a support grid having a frame with opposite upstream and downstream sides;
(b) a plurality of first filter elements oriented along the upstream side of the support grid; and
(c) a plurality of second filter elements oriented on the support grid on the downstream side directly across and opposing the first filter element

13. The system of claim 12 wherein:
(a) the first filter elements comprise pocket filter elements; and
(b) the second filter elements comprise V-bank filter elements.

14. The system of claim 12 further including a single clamp system releasably securing both the first filter elements and the second filter elements to the frame.

15. The system of claim 1 further including an evaporative cooling system downstream of the filter arrangement.

16. The system of claim 1 further including an electronic monitoring system to manage one or all of pressure, temperature, and humidity.

17. The system of claim 1 wherein the filter arrangement is located outside of the barn enclosure.

18. A method for filtering a livestock enclosure; the method comprising:
(a) providing a barn enclosure including a surrounding wall and a ceiling; the enclosure being sized to house livestock; the barn enclosure having an air inlet in communication with the interior of the barn enclosure drawing in ambient air;
(b) providing the barn enclosure with a positive internal pressure differential compared to ambient air;
(c) drawing in ambient air through the air inlet;
(d) filtering the drawn in ambient air from the air inlet by passing the drawn in air through a filter arrangement;
(e) venting the filtered air through a conduit to flow into the interior of the barn enclosure; and
exhausting air from the interior of the barn enclosure through an air exhaust.

19. The method of claim 18 wherein filtering through the filter arrangement includes filtering through a plurality of removable and replaceable filter elements.

20. The method of claim 19 wherein filtering through a plurality of removable and replaceable filter elements includes a number of filter elements determined by an equation:
S=(n_{LV}×f_{LV})/f_{Rated}
wherein:
S=−number of filter elements;
n_{LV}: Total number of livestock to be housed;
f_{LV}: Desired flow per livestock, cfm;
f_{Rated}: Rated flow per filter element, cfm.
